(19) United States
(12) Patent Application Publication
(10) Pub. No.: US 2015/0380965 A1
(43) Pub. Date: Dec. 31, 2015

(54) HYBRID POWER CONVERTER STAGE

(71) Applicant: Infineon Technologies AG, Neubiberg (DE)

(72) Inventors: Wai Keung Lun, Hong Kong (HK); Ho Chun Lee, Hong Kong (HK)

(21) Appl. No.: 14/320,042

(22) Filed: Jun. 30, 2014

(51) Int. Cl. H02J 7/00

(52) U.S. Cl. CPC H02J 7/0052; H02J 7/0042

(57) ABSTRACT

In one example, a method includes generating, by one or more active circuit elements of a power converter and during a charging state, a first DC power signal from an input power signal; outputting, during the charging state, the first DC power signal to a battery; receiving, during a discharging state, a second DC power signal from the battery; generating, by the same one or more active circuit elements of the power converter and during the discharging state, an AC power signal from the second DC power signal; and outputting, during the discharging state, the AC power signal to a load.

### TECHNICAL FIELD

This disclosure relates to power converters.

### BACKGROUND

Power converters may be used to generate an output power signal by converting one or more aspects of an input power signal. As one example, a DC/DC power converter may convert an input DC power signal at a first voltage level into an output DC power signal at a second voltage level. As another example, an AC/DC power converter may rectify an input AC power signal into an output DC power signal. As yet another example, a DC/AC power converter may invert an input DC power signal into an output AC power signal. In some examples, a power converter may include multiple stages. For instance, a power converter may include a DC/DC stage and a DC/AC stage.

### SUMMARY

In general, this disclosure is directed to techniques for hybridizing multiple power converter stages. For instance, one or more active circuit elements (e.g., one or more switches/transistors) of a hybridized power converter stage may be used to perform both DC/DC and DC/AC power conversion.

In one example, a method includes generating, by one or more active circuit elements of a power converter and during a charging state, a first DC power signal from an input power signal; outputting, during the charging state, the first DC power signal to a battery; receiving, during a discharging state, a second DC power signal from the battery; generating, by the same one or more active circuit elements of the power converter and during the discharging state, an AC power signal from the second DC power signal; and outputting, during the discharging state, the AC power signal to a load.

In another example, a power converter device includes: one or more connectors configured to: receive, during a charging state, an input power signal, output, during the charging state, a first DC power signal to a battery, receive, during a discharging state, a second DC power signal from the battery, and output, during a discharging state, an AC power signal to a load; and one or more active circuit elements configured to: generate, during the charging state, the first DC power signal from the input power signal, and generate, during the discharging state, the AC power signal from the second DC power signal.

In another example, a power converter device includes means for generating, during a charging state, a first DC power signal from an input power signal; means for outputting, during the charging state, the first DC power signal to a battery; means for receiving, during a discharging state, a second DC power signal from the battery; means for generating, during the discharging state, an AC power signal from the second DC power signal, wherein the means for generating the first DC power signal and the means for generating the AC power signal have at least one active circuit element in common; and means for outputting, during the discharging state, the AC power signal to a load.

Details of these and other examples are set forth in the accompanying drawings and the description below. Other features, objects, and advantages will be apparent from the description and drawings, and from the claims.

### BRIEF DESCRIPTION OF DRAWINGS

FIG. 1 is a conceptual diagram illustrating an example battery powered motor system, in accordance with one or more techniques of this disclosure.

FIGS. 2A and 2B are conceptual diagrams illustrating further details of the example battery powered motor system of FIG. 1, in accordance with one or more examples of this disclosure.

FIG. 3 is a conceptual diagram illustrating another example battery powered motor system, in accordance with one or more techniques of this disclosure.

FIGS. 4A and 4B are conceptual diagrams illustrating further details of the example battery powered motor system of FIG. 3, in accordance with one or more examples of this disclosure.

FIG. 5 is a flowchart illustrating example operations of an example battery powered motor system, in accordance with one or more techniques of this disclosure.

### DETAILED DESCRIPTION

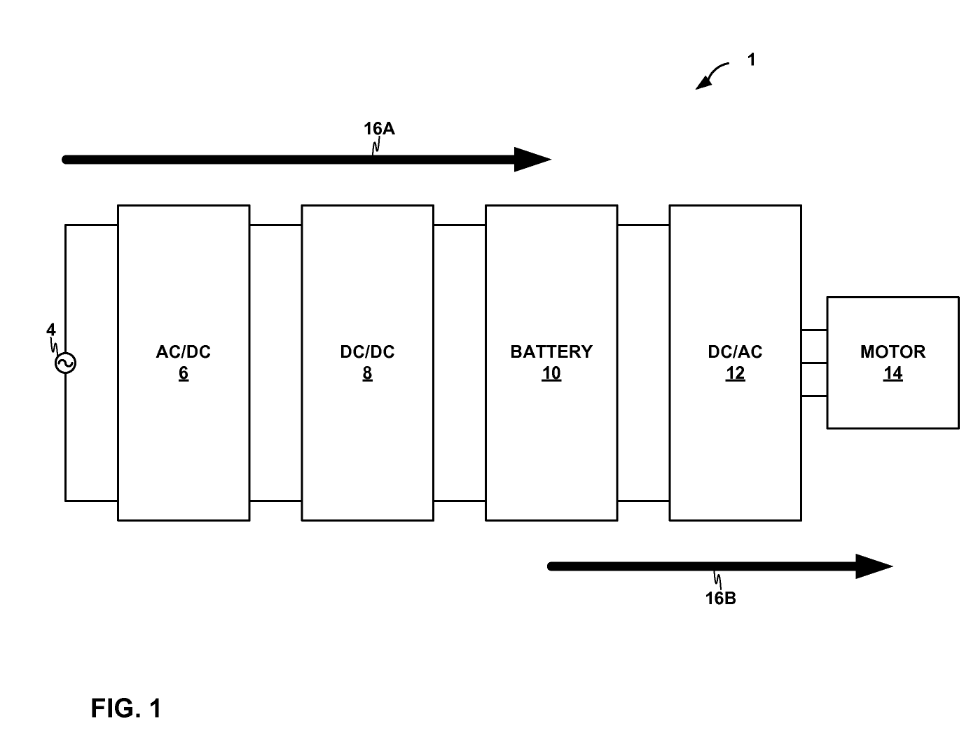

FIG. 1 is a conceptual diagram illustrating example battery powered motor system 1, in accordance with one or more techniques of this disclosure. As illustrated in the example of FIG. 1, system 1 may include power source 4, AC/DC stage 6, DC/DC stage 8, battery 10, DC/AC stage 12, and motor 14. In some examples, system 1 may be included in a vehicle. For instance, system 1 may be included in an electrical vehicle (EV), such as a plug-in electrical vehicle (PEV), a hybrid electric vehicle, a plug-in hybrid vehicle (PHEV), and the like.

In some examples, system 1 may include power source 4 which may be configured to provide power to one or more other components of system 1. For instance, power source 4 may be configured to provide an input power signal to AC/DC stage 6. In some examples, power source 4 may represent a connection to an electrical supply grid. In some examples, the input power signal provided by power source 4 may be an AC input power signal. For instance, power source 4 may be configured to provide an AC input power signal in the range or −85 VAC to −400 VAC.

In some examples, system 1 may include AC/DC stage 6 which may be configured to convert a received AC power signal into a DC power signal. For instance, AC/DC stage 6 may convert an AC input power signal received from power source 4 into a DC power signal. In some examples, AC/DC stage 6 may include a rectifier, such as a bridge rectifier. In some examples, AC/DC stage 6 may include a power factor corrector (PFC), such as a continuous conduction mode (CCM) PFC. In any case, AC/DC stage 6 may be configured to output the DC power signal to one or more other components of system 1, such as DC/DC stage 8.

In some examples, system 1 may include DC/DC stage 8 which may be configured to convert a first DC power signal into a second DC power signal. For instance, DC/DC stage 8 may be configured to convert a first DC power signal received from AC/DC stage 6 into a second DC power signal. In some examples, DC/DC stage 8 may perform the conversion by adjusting a voltage level. For instance, DC/DC stage 8 may convert a first DC power signal at ˜400 volts into a second DC power signal at ˜48 volts to ˜96 volts. In any case, DC/DC stage 8 may be configured to output the second DC power signal to one or more other components of system 1, such as battery 10. For instance, DC/DC stage 8 may be configured to output the second DC power signal so as to charge battery 10.

In some examples, system 1 may include battery 10 which may be configured to store electrical energy. In some examples, battery 10 may be a rechargeable battery. For instance, battery 10 may be configured to store additional electrical energy during a charging state and provide its stored electrical energy to one or more other components during a discharging state. As one example, during the charging state, battery 10 may store electrical energy provided in the form of a DC power signal, such as the second DC power signal provided by DC/DC stage 8. As another example, during the discharging state, battery 10 may be configured to provide its stored electrical energy in the form of a DC power signal to, e.g., DC/AC stage 12. Examples of battery 10 may include, but are not limited to, nickel-cadmium, lead-acid, nickel-metal hydride, nickel-zinc, silver-oxide, lithium-ion, lithium polymer, any other type of rechargeable battery, or any combination of the same. In some examples, the voltage of the DC power signal provided by battery 10 may be in the range of approximately 48 volts to approximately 96 volts.

In some examples, system 1 may include DC/AC stage 12 which may be configured to convert a DC power signal into an AC power signal, and output the AC power signal to one or more other components of system 1. For instance, DC/AC stage 12 may convert a DC power signal received from battery 10 into an AC power signal, and output the AC power signal to motor 14. In some examples, DC/AC stage 12 may be configured to convert a DC power signal into a multi-phase AC power signal. For instance, DC/AC stage 12 may convert a DC power signal into a three-phase AC power signal.

In some examples, system 1 may include motor 14 which may be configured to convert electrical energy into kinetic energy. For instance, where system 1 is included in a vehicle, motor 14 may be configured to propel the vehicle (e.g., to provide a mechanical driving force to one or more wheels, turbines, propellers, rotors, treads, or other elements that can help propel the vehicle). In some examples, motor 14 may be a multi-phase electrical motor. For instance, motor 14 may be a three-phase electrical motor.

In operation, system 1 may operate in a charging state, a neutral state, and a discharging state. For instance, where system 1 is included in a vehicle, system 1 may operate in the charging state while the vehicle is parked and connected to power source 4. Similarly, system 1 may operate in the discharging state while motor 14 is propelling the vehicle.

During the charging state, electrical energy may flow through system 1 in a direction indicated by arrow 16A. For instance, power source 4 may provide a first AC power signal (e.g., a 400 volt AC power signal) to AC/DC stage 6. AC/DC stage 6 may convert the first AC power signal into a first DC power signal (e.g., a 400 volt DC power signal) and provide the first DC power signal to DC/DC stage 8. DC/DC stage 8 may convert the first DC power signal into a second DC power signal (e.g., a 96 volt DC power signal) and output the second DC power signal to battery 10. In this way, system 1 may store electrical energy in battery 10 during the charging state.

During the discharging state, electrical energy may flow through system 1 in a direction indicated by arrow 16B. For instance, battery 10 may provide a third DC power signal (e.g., a 96 volt DC power signal) to DC/AC stage 12. DC/AC stage 12 may convert the third DC power signal into a second AC power signal (e.g., a three-phase AC power signal) and output the second AC power signal to motor 14. Motor 14 may convert the second AC power signal into kinetic energy to, e.g., propel a vehicle. In this way, system 1 may utilize electrical energy stored by battery 10 during the discharging state.

However, in some examples, it may not be desirable to include DC/DC stage 8 and DC/AC stage 12 as separate and distinct components. For instance, including DC/DC stage 8 and DC/AC stage 12 as separate and distinct components may occupy a large area/volume, result in complicated system connections, reduced efficiency (e.g., due to more power conversion stages), and component redundancy.

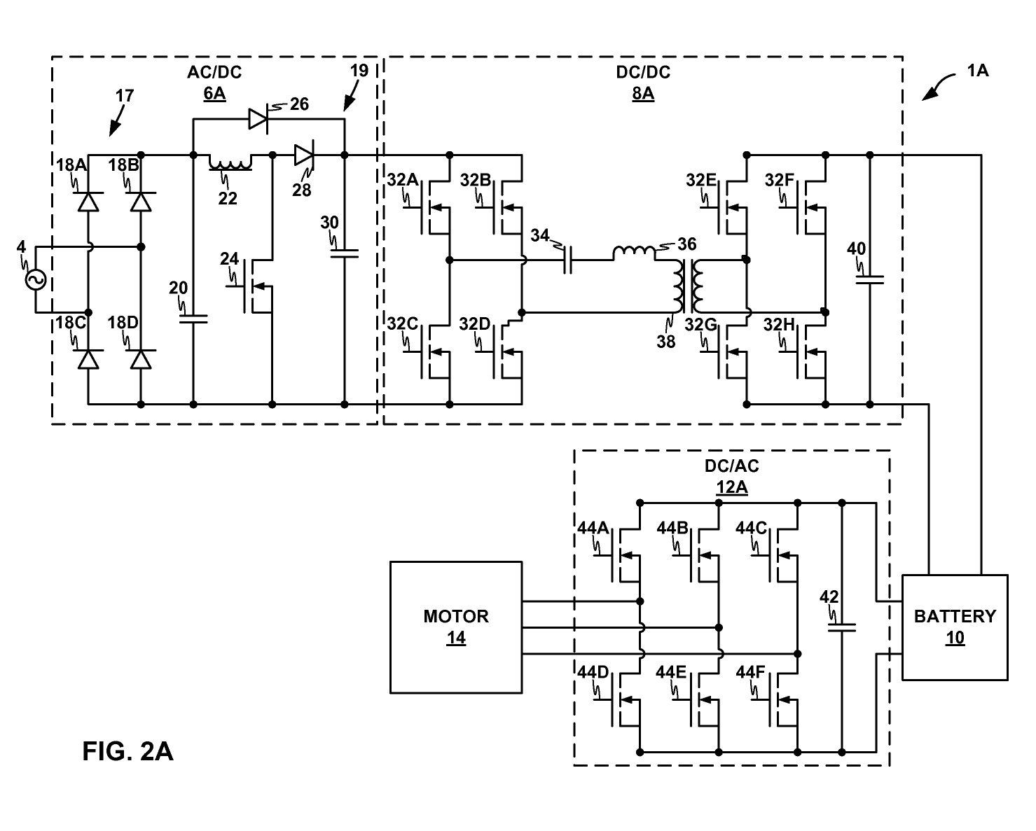

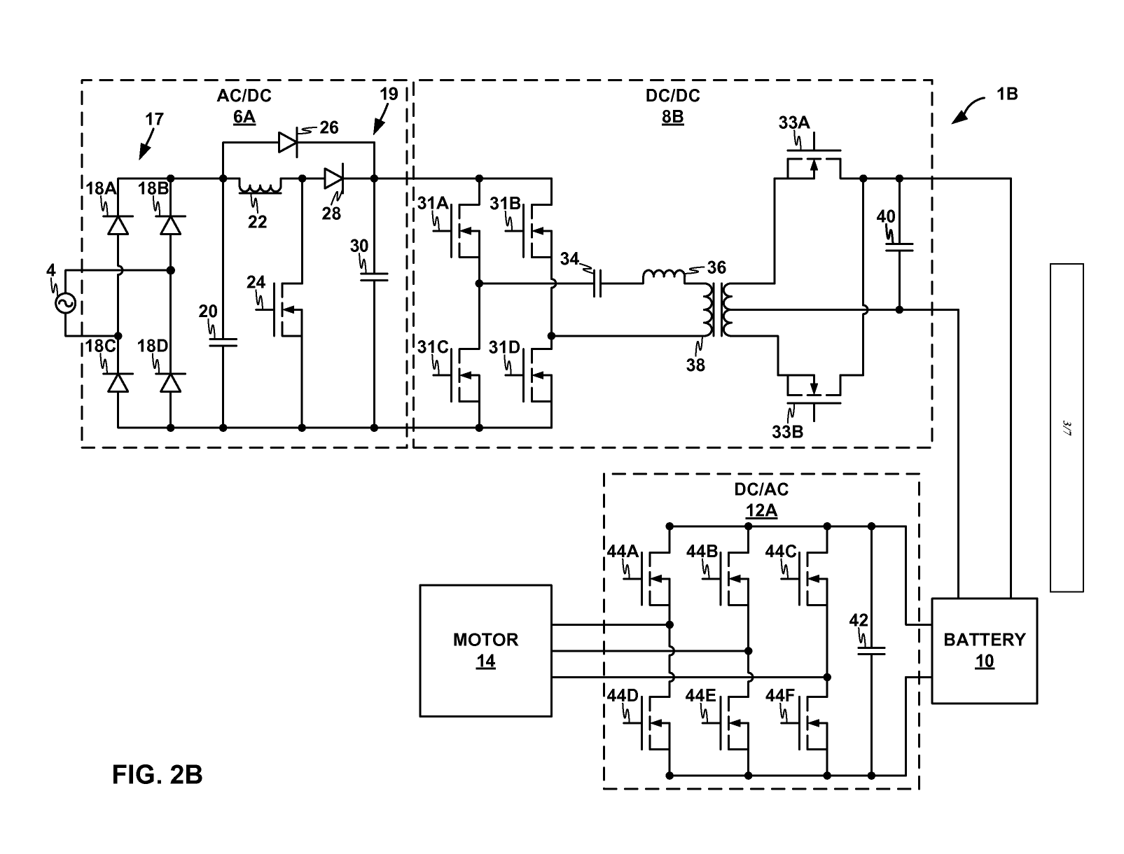

FIGS. 2A and 2B are conceptual diagrams illustrating further details of the example battery powered motor systems of FIG. 1, in accordance with one or more examples of this disclosure. As illustrated in FIG. 2A, system 1A may include power source 4, AC/DC stage 6A, DC/DC stage 8A, battery 10, DC/AC stage 12A, and motor 14. As another example, as illustrated in FIG. 2B, system 1A may include power source 4, AC/DC stage 6A, DC/DC stage 8B, battery 10, DC/AC stage 12A, and motor 14.

In some examples, system 1A and/or 1B may include power source 4, battery 10, and motor 14 which may be configured to perform operations similar to power source 4, battery 10, and motor 14 of FIG. 1. For instance, power source 4 may be configured to provide power to one or more other components of system 1A or 1B, battery 10 may be configured to store electrical energy during a charging state and output electrical energy during a discharging state, and motor 14 may be configured to convert electrical energy into kinetic energy.

In some examples, system 1A and/or 1B may include AC/DC stage 6A which may be configured to perform operations similar to AC/DC stage 6 of FIG. 1. For instance AC/DC stage 6A may be configured to convert a received AC power signal into a DC power signal. As illustrated in FIG. 2A, AC/DC stage 6A may include rectifier 17, and PFC 19.

In some examples, AC/DC stage 6A may include rectifier 17 which may be configured to rectify a received AC power signal into a DC power signal. In some examples, rectifier may include diodes 18A-18D (collectively, “diodes 18”). As illustrated in FIG. 2A, diodes 18 may be arranged in an H-bridge configuration.

In some examples, AC/DC stage 6A may include PFC 19 which may be configured to adjust a power factor of a signal. In some examples, PFC 19 may be a continuous conduction mode (CCM) PFC. As illustrated in FIG. 2A, PFC 19 may include capacitor 20, inductor 22, transistor 14, diode 26, diode 28, and capacitor 30.

In some examples, system 1A may include DC/DC stage 8A which may be configured to perform operations similar to DC/DC stage 8 of FIG. 1. For instance, DC/DC stage 8A may be configured to convert a first DC power signal into a second DC power signal. In some examples, DC/DC stage 8A may include transistors 32A-32H (collectively, “transistors 32”), capacitor 34, inductor 36, transformer 38, and capacitor 40. As illustrated in FIG. 2A, the components of DC/DC stage 8A may be arranged in a HB-LLC topology.

In some examples, system 1B may include DC/DC stage 8B which may be configured to perform operations similar to DC/DC stage 8 of FIG. 1 and/or DC/DC stage 8A of FIG. 2A. For instance, DC/DC stage 8B may be configured to convert a first DC power signal into a second DC power signal. In some examples, DC/DC stage 8B may include transistors 31A-31D (collectively, “transistors 31”), transistors 33A and 33B (collectively, “transistors 33”), capacitor 34, inductor 36, transformer 38, and capacitor 40. As illustrated in FIG. 2B, the components of DC/DC stage 8B may be arranged in a HB-LLC topology.

In some examples, system 1A and/or 1B may include DC/AC stage 12A which may be configured to perform operations similar to DC/AC stage 12 of FIG. 1. For instance, DC/AC stage 12A may be configured to convert a DC power signal into an AC power signal, and output the AC power signal to one or more other components of system 1A or 1B. In some examples, DC/AC stage 12A may include capacitor 42, and transistors 44A-44F (collectively, “transistors 44”). As illustrated in FIG. 2A, transistors 44 may be arranged in a B6 topology.

As discussed above, it may not be desirable to include DC/DC stage 8A/8B and DC/AC stage 12A as separate and distinct components. As one example, including DC/DC stage 8A/8B and DC/AC stage 12A as separate and distinct components may occupy a large area/volume, result in complicated system connections, reduced efficiency (e.g., due to more power conversion stages), and component redundancy. For instance, including DC/DC stage 8A/8B and DC/AC stage 12A as separate and distinct components may result in component redundancy because the components of DC/DC 8A/8B are used during the charging state and idle during the discharging state while the components of DC/AC 12A are used during the discharging state and idle during the charging state.

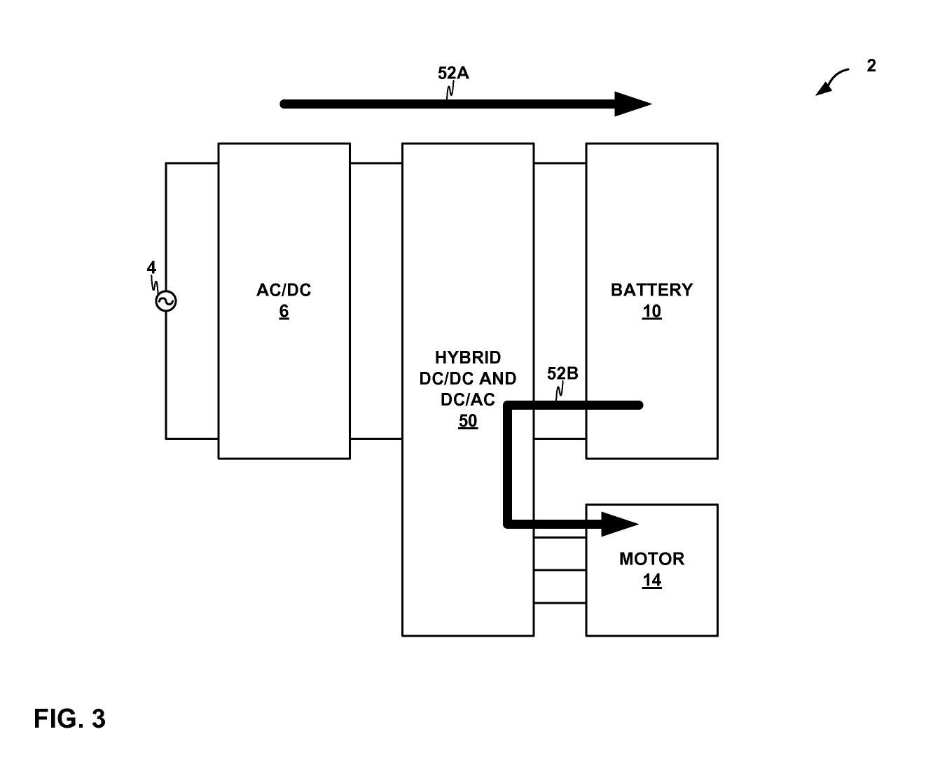

FIG. 3 is a conceptual diagram illustrating example battery powered motor system 2, in accordance with one or more techniques of this disclosure. As illustrated in the example of FIG. 3, system 2 may include power source 4, AC/DC stage 6, battery 10, hybrid DC/DC and DC/AC stage 50 (hereinafter “hybrid stage 50”), and motor 14. In some examples, system 2 may perform operations similar to system 1 of FIG. 1. For instance, system 2 may be configured to operate in a charging state where electrical energy is stored in battery 10, and a discharging state where the electrical energy stored in battery 10 is utilized to operate motor 14. Similarly to system 1, system 2 may be included in a vehicle.

In some examples, system 2 may include power source 4, AC/DC stage 6, battery 10, and motor 14 which may be configured to perform operations similar to power source 4, AC/DC stage 6/6A, battery 10, and motor 14 of FIG. 1, and/or FIGS. 2A and 2B. For instance, power source 4 may be configured to provide power to one or more other components of system 2, AC/DC stage 6 may be configured to convert a received AC power signal into a DC power signal, battery 10 may be configured to store electrical energy during a charging state and output electrical energy during a discharging state, and motor 14 may be configured to convert electrical energy into kinetic energy.

In some examples, system 2 may include hybrid stage 50 which may be configured to operate as a DC/DC stage during a charging state and operate as a DC/AC stage during a discharging state. For instance, hybrid stage 50 may perform operations similar to DC/DC stage 8 of FIG. 1 during the charging state, and operations similar to DC/AC stage 12 of FIG. 1 during the discharging state.

In accordance with one or more techniques of this disclosure, hybrid stage 50 may be configured to use one or more active circuit elements during both the charging state and the discharging state. For instance, hybrid stage 50 may utilize one or more active circuit elements, such as one or more transistors, to generate a DC power signal during the charging state, and utilize the same one or more active circuit elements to generate an AC power signal during the discharging state. In this way, hybrid stage 50 may perform operations similar to separate DC/DC and DC/AC stages with increased efficiency, reduced system size, and/or a reduced quantity of components.

During the charging state, electrical energy may flow through system 2 in a direction indicated by arrow 52A. For instance, power source 4 may provide a first AC power signal (e.g., a 400 volt AC power signal) to AC/DC stage 6. AC/DC stage 6 may generate a first DC power signal (e.g., a 400 volt DC power signal) from the first AC power signal and provide the first DC power signal to hybrid stage 50. One or more active circuit elements of hybrid stage 50 may generate a second DC power signal (e.g., a 96 volt DC power signal) from the first DC power signal and output the second DC power signal to battery 10. In this way, system 2 may store electrical energy in battery 10 during the charging state.

During the discharging state, electrical energy may flow through system 2 in a direction indicated by arrow 52B. For instance, battery 10 may provide a third DC power signal (e.g., a 96 volt DC power signal) to hybrid stage 50. Some or all of the same one or more active circuit elements of hybrid stage 50 that were used to generate the second DC power signal may generate a second AC power signal (e.g., a three-phase AC power signal) from the third DC power signal and output the second AC power signal to motor 14. Motor 14 may convert the second AC power signal into kinetic energy to, e.g., propel a vehicle. In this way, system 2 may utilize electrical energy stored by battery 10 during the discharging state.

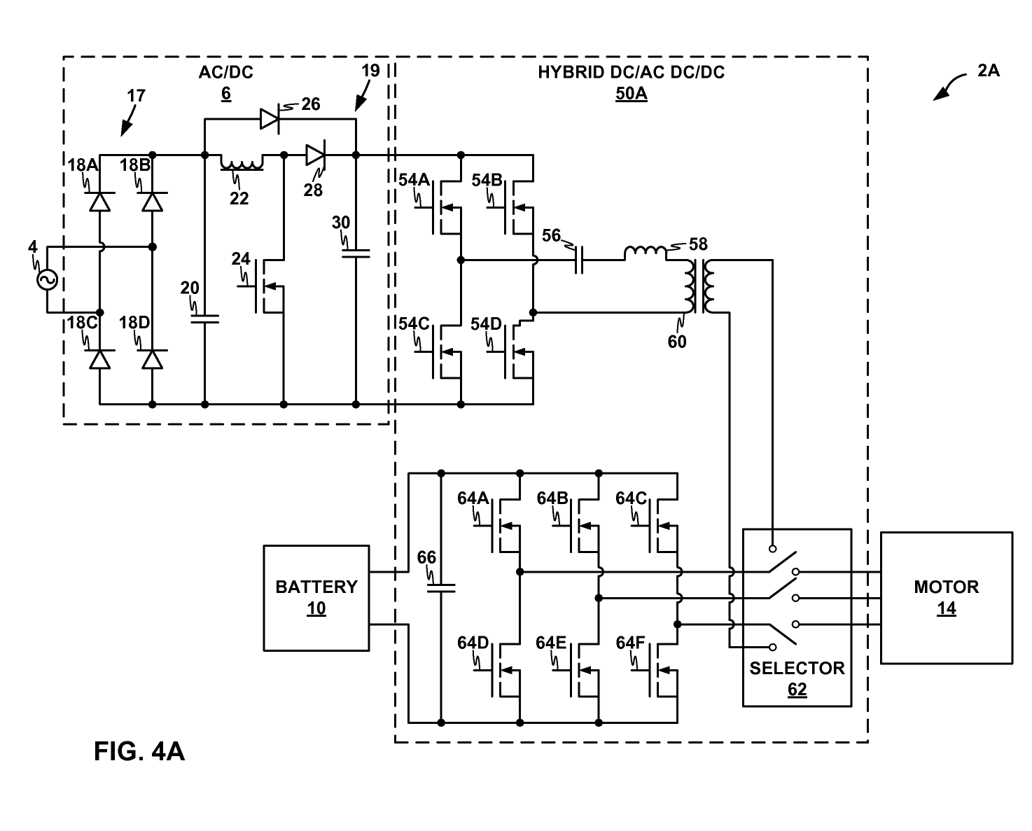

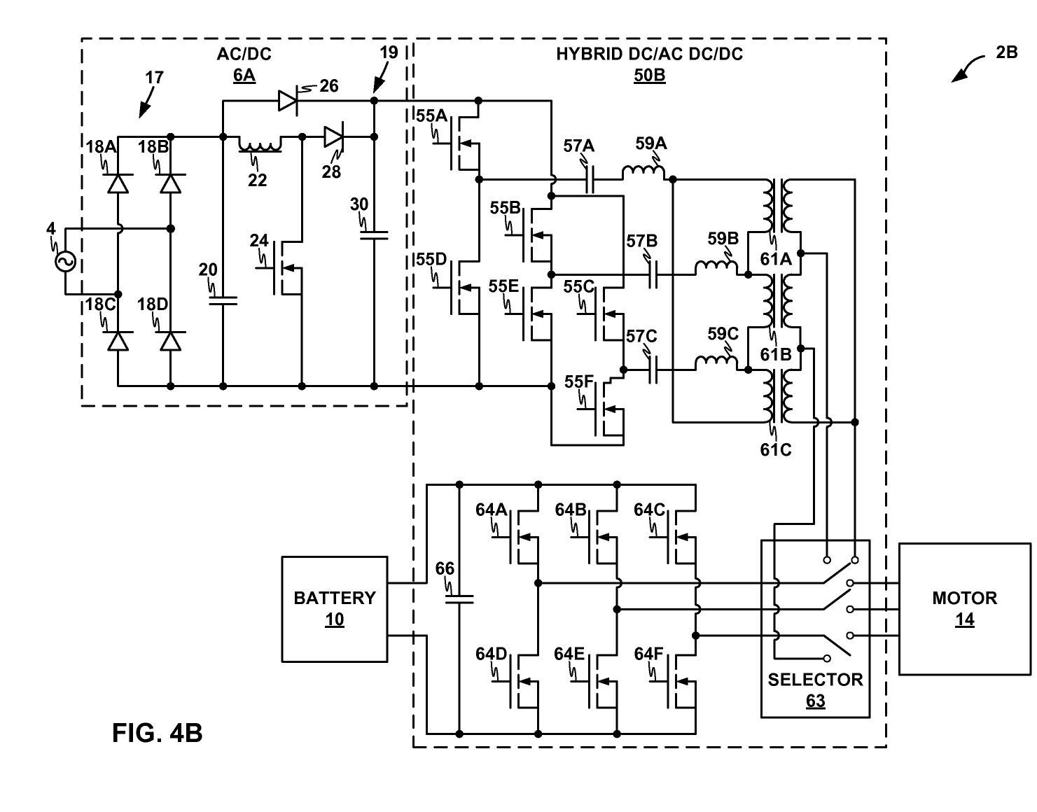

FIGS. 4A and 4B are conceptual diagrams illustrating further details of the example battery powered motor system of FIG. 3, in accordance with one or more examples of this disclosure. As illustrated in FIG. 4A, system 2A may include power source 4, AC/DC stage 6A, hybrid stage 50A, battery 10, and motor 14. As another example, as illustrated in FIG. 4B, system 1A may include power source 4, AC/DC stage 6A, hybrid stage 50B, battery 10, and motor 14.

In some examples, system 2A and/or 2B may include power source 4, battery 10, and motor 14 which may be configured to perform operations similar to power source 4, battery 10, and motor 14 of FIG. 1, FIGS. 2A and 2B, and FIG. 3. For instance, power source 4 may be configured to provide power to one or more other components of system 2A or 2B, battery 10 may be configured to store electrical energy during a charging state and output electrical energy during a discharging state, and motor 14 may be configured to convert electrical energy into kinetic energy.

As illustrated in FIG. 4A, system 2A may, in some examples, include hybrid stage 50A which may be configured to perform operations similar to hybrid stage 50 of FIG. 3. For instance, hybrid stage 50A may be configured to operate as a DC/DC stage during a charging state and operate as a DC/AC stage during a discharging state. In some examples, hybrid stage 50A may include transistors 54A-54D (collectively, “transistors 54”), capacitor 56, inductor 58, transformer 60, selector 62, transistors 64A-64F (collectively, “transistors 64”), and capacitor 66. In some examples, each of transistors 64 may include an anti-parallel diode. While described herein as transistors, any type of switch may be used to perform the operations of transistors 64. In some examples, each of transistors 54 and transistors 64 may represent a plurality of transistors configured to operate in parallel.

In some examples, hybrid stage 50A may include selector 62 which may be configured to selectively configure hybrid stage 50A for the charging state or the discharging state. As one example, selector 62 may configure hybrid stage 50A for the charging state by at least coupling at least one active circuit element of hybrid stage 50A to a power source such that the at least one active circuit element may generate a DC power signal to charge battery 10. As another example, selector 62 may configure hybrid stage 50A for the discharging state by at least coupling the same at least one active circuit element of hybrid stage 50A to motor 14 such that the at least one active circuit element may generate an AC power signal to operate motor 14.

As discussed above and in accordance with one or more techniques of this disclosure, one or more active components of hybrid stage 50A may be used to both generate a DC power signal during the charging state, and generate an AC power signal during the discharging state. During an example charging state, selector 62 may configure hybrid stage 50A such that transistors 64A, 64C, 64D, and 64F may (along with transistors 54, capacitor 56, inductor 58, transformer 60, and capacitor 66) generate a DC power signal to, e.g., charge battery 10. During an example discharging state, selector 62 may configure hybrid stage 50A such that transistors 64A, 64C, 64D, and 64F may (along with transistors 64B and 64E) generate an AC power signal to, e.g., operate motor 14. In this way, transistors 64A, 64C, 64D, and 64F of hybrid stage 50A may be used to both generate a DC power signal during the charging state, and generate an AC power signal during the discharging state.

As illustrated in FIG. 4B, system 2B may, in some examples, include hybrid stage 50B which may be configured to perform operations similar to hybrid stage 50 of FIG. 3 and/or hybrid stage 50A of FIG. 4A. For instance, hybrid stage 50B may be configured to operate as a DC/DC stage during a charging state and operate as a DC/AC stage during a discharging state. In some examples, hybrid stage 50B may include transistors 55A-55F (collectively, “transistors 55”), capacitors 57A-57C (collectively, “capacitors 57”), inductors 59A-59C (collectively, “inductors 59”), transformers 61A-61C (collectively, “transformers 61”), selector 63, transistors 64A-64F (collectively, “transistors 64”), and capacitor 66. In some examples, each of transistors 55 and transistors 64 may represent a plurality of transistors configured to operate in parallel.

In some examples, hybrid stage 50B may include selector 63 which may be configured to selectively configure hybrid stage 50B for the charging state or the discharging state. As one example, selector 62 may configure hybrid stage 50B for the charging state by at least coupling at least one active circuit element of hybrid stage 50B to a power source such that the at least one active circuit element may generate a DC power signal to charge battery 10. As another example, selector 62 may configure hybrid stage 50B for the discharging state by at least coupling the same at least one active circuit element of hybrid stage 50B to motor 14 such that the at least one active circuit element may generate an AC power signal to operate motor 14.

As discussed above and in accordance with one or more techniques of this disclosure, one or more active components of hybrid stage 50B may be used to both generate a DC power signal during the charging state, and generate an AC power signal during the discharging state. During an example charging state, selector 63 may configure hybrid stage 50B such that transistors 64A-64F may (along with transistors 55, capacitors 57, inductors 59, transformers 61, and capacitor 66) generate a DC power signal to, e.g., charge battery 10. During an example discharging state, selector 63 may configure hybrid stage 50B such that transistors 64A-64F may generate an AC power signal to, e.g., operate motor 14. In this way, transistors 64A-64F of hybrid stage 50B may be used to both generate a DC power signal during the charging state, and generate an AC power signal during the discharging state.

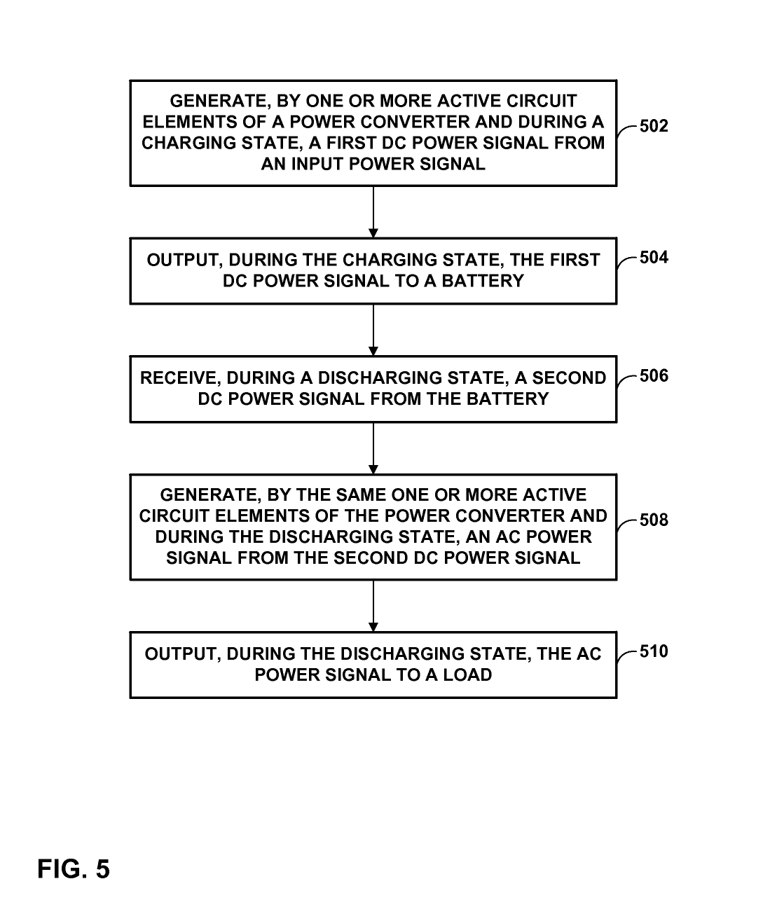

FIG. 5 is a flowchart illustrating example operations of an example battery powered motor system, in accordance with one or more techniques of this disclosure. For purposes of illustration only, the example operations are described below within the context of system 2, as shown in FIG. 3.

In accordance with one or more techniques of this disclosure, hybrid stage 50 of system 2 may generate, during a charging state and using one or more active circuit elements, a first DC power signal from an input power signal (502). In some examples, the one or more active circuit elements may be transistors, such as transistors 64A, 64C, 64D, and 64F of FIG. 4A. In some examples, the one or more active circuit elements may operate as a DC/DC stage during the charging state. For instance, where the input power signal is a DC power signal received from AC/DC stage 6, hybrid stage 50 may generate the first DC power signal by converting the received DC power signal. In some examples, such as where system 2 is included in a PEV, hybrid stage 50 may operate in the charging state when the vehicle is plugged-in such that electrical energy may be received from power source 4. In some examples, a selector may configure hybrid stage 50 to operate in the charging state by at least decoupling the one or more active circuit elements from a load, such as motor 14.

Hybrid stage 50 may output, during the charging state, the first DC power signal to a battery, such as battery 10 (504). In some examples, hybrid stage 50 may output the first DC power signal to the battery to store electrical energy the battery for later use, e.g., during a discharging state.

In some examples, a selector may configure hybrid stage 50 to operate in the discharging state by at least coupling the one or more active circuit elements to the load. In some examples, such as where system 2 is included in a PEV, hybrid stage 50 may operate in the discharging state when the vehicle is being operated, e.g., where the motor used to propel the vehicle using electrical energy stored in the battery.

Hybrid stage 50 may receive, during a discharging state, a second DC power signal from the battery (506). For instance, hybrid stage 50 may receive electrical energy stored by the battery in the form of the second DC power signal.

Hybrid stage 50 may generate, during the discharging state and using the same one or more active circuit elements used to generate the first DC power signal, an AC power signal from the second DC power signal (508). In some examples, such as where the load is a three-phase motor, hybrid stage may generate the AC power signal as a three-phase AC power signal.

Hybrid stage 50 may output, during the discharging state, the AC power signal to the load (510). For instance, where system 2 is included in a vehicle and the load is a motor, hybrid stage 50 may output the AC power signal to the load such that the motor causes the vehicle to accelerate.

The following examples may illustrate one or more aspects of the disclosure.

### EXAMPLE 1

A method comprising: generating, by one or more active circuit elements of a power converter and during a charging state, a first DC power signal from an input power signal; outputting, during the charging state, the first DC power signal to a battery; receiving, during a discharging state, a second DC power signal from the battery; generating, by the same one or more active circuit elements of the power converter and during the discharging state, an AC power signal from the second DC power signal; and outputting, during the discharging state, the AC power signal to a load.

### EXAMPLE 2

The method of example 1, wherein the input power signal is received from a power source, the method further comprising: configuring the power converter for the charging state by at least coupling at least one active circuit element of the one or more active circuit elements to the power source; and configuring the power converter for the discharging state by at least coupling the at least one active circuit element to the load.

### EXAMPLE 3

The method of any combination of examples 1-2, wherein: the one or more active circuit elements operate as a DC/DC stage during the charging state, and the one or more active circuit elements operate as a DC/AC stage during the discharging state.

### EXAMPLE 4

The method of any combination of examples 1-3, wherein the at least one active circuit element is a transistor.

### EXAMPLE 5

The method of any combination of examples 1-4, wherein the power converter is included in a vehicle, and wherein the load is an AC electric motor configured to propel the vehicle.

### EXAMPLE 6

The method of any combination of examples 1-5, wherein the charging state and the discharging state are non-overlapping.

### EXAMPLE 7

A power converter device comprising: one or more connectors configured to: receive, during a charging state, an input power signal, output, during the charging state, a first DC power signal to a battery, receive, during a discharging state, a second DC power signal from the battery, and output, during a discharging state, an AC power signal to a load; and one or more active circuit elements configured to: generate, during the charging state, the first DC power signal from the input power signal, and generate, during the discharging state, the AC power signal from the second DC power signal.

### EXAMPLE 8

The power converter device of example 7, wherein the input power signal is received from a power source, the power converter device further comprising: a selector configured to: operate the power converter device in the charging state by at least coupling at least one active circuit element of the one or more active circuit elements to the power source, and operate the power converter device in the discharging state by at least coupling the at least one active circuit element to the load.

### EXAMPLE 9

The power converter device of any combination of examples 7-8, wherein: the one or more active circuit elements are configured to operate as a DC/DC stage during the charging state, and the one or more active circuit elements are configured to operate as a DC/AC stage during the discharging state.

### EXAMPLE 10

The power converter device of any combination of examples 7-9, wherein the at least one active circuit element is a transistor.

### EXAMPLE 11

The power converter device of any combination of examples 7-10, wherein the power converter is included in a vehicle, and wherein the load is an AC electric motor configured to propel the vehicle.

### EXAMPLE 12

The power converter device of any combination of examples 7-11, wherein the charging state and the discharging state are non-overlapping.

### EXAMPLE 13

A power converter device comprising: means for generating, during a charging state, a first DC power signal from an input power signal; means for outputting, during the charging state, the first DC power signal to a battery; means for receiving, during a discharging state, a second DC power signal from the battery; means for generating, during the discharging state, an AC power signal from the second DC power signal, wherein the means for generating the first DC power signal and the means for generating the AC power signal have at least one active circuit element in common; and means for outputting, during the discharging state, the AC power signal to a load.

### EXAMPLE 14

The power converter device of example 13, further comprising: means for configuring the power converter for the charging state that at least include means for coupling the at least one active circuit element to a power source; and means for configuring the power converter for the discharging state that at least include means for coupling the at least one active circuit element to the load.

### EXAMPLE 15

The power converter device of any combination of examples 13-14, wherein the power converter device is included in a vehicle, and wherein the load is an AC electric motor configured to propel the vehicle.

### EXAMPLE 16

The method of any combination of examples 13-15, wherein the AC power signal is a multi-phase AC power signal.

### EXAMPLE 17

The power converter device of any combination of examples 13-16, wherein the charging state and the discharging state are non-overlapping.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in an article of manufacture including a computer-readable storage medium encoded with instructions. Instructions embedded or encoded in an article of manufacture including a computer-readable storage medium encoded, may cause one or more programmable processors, or other processors, to implement one or more of the techniques described herein, such as when instructions included or encoded in the computer-readable storage medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may include one or more computer-readable storage media.

In some examples, a computer-readable storage medium may include a non-transitory medium. The term “non-transitory” may indicate that the storage medium is not embodied in a carrier wave or a propagated signal. In certain examples, a non-transitory storage medium may store data that can, over time, change (e.g., in RAM or cache).

Various aspects have been described in this disclosure. These and other aspects are within the scope of the following claims.

1. A method comprising:
generating, by one or more active circuit elements of a power converter and during a charging state, a first DC power signal from an input power signal;
outputting, during the charging state, the first DC power signal to a battery;
receiving, during a discharging state, a second DC power signal from the battery;
generating, by the same one or more active circuit elements of the power converter and during the discharging state, an AC power signal from the second DC power signal; and
outputting, during the discharging state, the AC power signal to a load.

2. The method of claim 1, wherein the input power signal is received from a power source, the method further comprising:
configuring the power converter for the charging state by at least coupling at least one active circuit element of the one or more active circuit elements to the power source; and
configuring the power converter for the discharging state by at least coupling the at least one active circuit element to the load.

3. The method of claim 1, wherein:
the one or more active circuit elements operate as a DC/DC stage during the charging state, and
the one or more active circuit elements operate as a DC/AC stage during the discharging state.

4. The method of claim 1, wherein the at least one active circuit element is a transistor.

5. The method of claim 1, wherein the power converter is included in a vehicle, and wherein the load is an AC electric motor configured to propel the vehicle.

6. The method of claim 1, wherein the charging state and the discharging state are non-overlapping.

7. A power converter device comprising:
one or more connectors configured to:
receive, during a charging state, an input power signal,
output, during the charging state, a first DC power signal to a battery,
receive, during a discharging state, a second DC power signal from the battery, and
output, during a discharging state, an AC power signal to a load; and
one or more active circuit elements configured to:
generate, during the charging state, the first DC power signal from the input power signal, and
generate, during the discharging state, the AC power signal from the second DC power signal.

8. The power converter device of claim 7, wherein the input power signal is received from a power source, the power converter device further comprising:
a selector configured to:
operate the power converter device in the charging state by at least coupling at least one active circuit element of the one or more active circuit elements to the power source, and
operate the power converter device in the discharging state by at least coupling the at least one active circuit element to the load.

9. The power converter device of claim 7, wherein:
the one or more active circuit elements are configured to operate as a DC/DC stage during the charging state, and
the one or more active circuit elements are configured to operate as a DC/AC stage during the discharging state.

10. The power converter device of claim 7, wherein the at least one active circuit element is a transistor.

11. The power converter device of claim 7, wherein the power converter is included in a vehicle, and wherein the load is an AC electric motor configured to propel the vehicle.

12. The power converter device of claim 7, wherein the charging state and the discharging state are non-overlapping.

13. A power converter device comprising:
means for generating, during a charging state, a first DC power signal from an input power signal;
means for outputting, during the charging state, the first DC power signal to a battery;
means for receiving, during a discharging state, a second DC power signal from the battery;
means for generating, during the discharging state, an AC power signal from the second DC power signal, wherein the means for generating the first DC power signal and the means for generating the AC power signal have at least one active circuit element in common; and
means for outputting, during the discharging state, the AC power signal to a load.

14. The power converter device of claim 13, further comprising:
means for configuring the power converter for the charging state that at least include means for coupling the at least one active circuit element to a power source; and
means for configuring the power converter for the discharging state that at least include means for coupling the at least one active circuit element to the load.

15. The power converter device of claim 13, wherein the power converter device is included in a vehicle, and wherein the load is an AC electric motor configured to propel the vehicle.

16. The power converter device of claim 13, wherein the AC power signal is a multi-phase AC power signal.

17. The power converter device of claim 13, wherein the charging state and the discharging state are non-overlapping.
